(19) United States
(12) Patent Application Publication
(10) Pub. No.: US 2026/0031679 A1
(43) Pub. Date: Jan. 29, 2026

(54) ACTUATOR WITH A MOTOR

(71) Applicant: HELLA GMBH & CO. KGAA, Lippstadt (DE)

(72) Inventors: Bodo Bücker, Arnsberg (DE); Matthias Humpe, Oelde (DE); Jost Kleine-Weischede, Kamen (DE); Marc Pingel, Lippstadt (DE); Katrin Zimmermann, Soest (DE)

(21) Appl. No.: 19/349,046

(22) Filed: Oct. 3, 2025

Related U.S. Application Data
(63) Continuation of application No. PCT/EP2024/057648, filed on Mar. 21, 2024.

(30) Foreign Application Priority Data
Apr. 4, 2023 (DE) 102023108597.2

(51) Int. Cl. H02K 7/116; F16H 55/06

(52) U.S. Cl. CPC H02K 7/116; F16H 55/06; F16H 2055/065

(57) ABSTRACT

The invention relates to an actuator with a motor and a gearing mechanism. The motor has a stator and a rotor with at least one permanent magnet. The gearing mechanism has a first gear and a second gear which mesh with each other. The actuator has a plastic part which forms a part of the rotor and the first gear. The permanent magnet is embedded in the plastic part, and the gears have helical teeth.

### CROSS-REFERENCE TO RELATED APPLICATIONS

The present application is a continuation of PCT/EP2024/057648, filed Mar. 21, 2024, which claims priority to German Patent Application DE 10-2023-108-597.2, filed Apr. 4, 2023, the disclosures of which are incorporated by reference in their entirety.

### BACKGROUND OF THE INVENTION

The invention relates to an actuator with a motor and a gearing mechanism, wherein the motor has a stator and a rotor with at least one permanent magnet, wherein the gearing mechanism comprises a first gear and a second gear which mesh with each other, and wherein the actuator has plastic parts that form part of the rotor and the first gear, wherein the permanent magnet is embedded in the plastic part.

Such a motor is known from the document DE 10-2013-022-654 B3. Actuators in motor vehicles often have to be small, as there is often little space available for installing the actuators in a vehicle. So they have to be small and inexpensive at the same time. These requirements result in small gears that often have a large number of teeth. This high number of teeth usually leads to acoustic problems in the first gear stage at high speeds.

These problems have so far been addressed with the following approaches. One approach is to provide fewer teeth on the gears in the first stage, which allows smaller distances between the axles to be realized. This results in excitation at a lower frequency, which counteracts the acoustic problems. However, additional gear stages are then required to compensate for this. In another approach, retaining arms and/or springs are used to achieve stabilization of the first gear stage. Besides that, grease reservoirs are provided with which improved system damping in the first gear stage can be achieved. It is further known to select gears with high-starting teeth in which at least two teeth are in mesh at the same time.

The first three approaches in particular are associated with additional construction effort. Additional components make the device more expensive. The last approach at least leads to larger gears.

### SUMMARY OF THE INVENTION

This is where the present invention comes in. The present invention is based on the problem of noise reduction in high-speed gearing mechanisms with small gears with a large number of teeth.

According to the invention, this object is achieved by the control unit having helical teeth. The helical teeth reduce the frequency excitation in this first gear stage, which leads to a significant reduction in the sound power level [dB (A)]. Compared to the aforementioned approaches, helical teeth lead to an acoustic optimization with low costs and installation space at the same time.

The plastic part of an actuator according to the invention can be a plastic injection molded part. The permanent magnet can then be overmolded with the plastic of the plastic injection molded part. It is possible that the second gear is a plastic part, in particular a plastic injection molded part. The helical teeth can have a helix angle of approximately 30°.

The plastic part can be made of polyoxymethylene (POM). The second gear can be made of polyamide (PA), in particular polyamide 6 reinforced with 40% glass fibers by weight (PA6 GF40). However, they are not limited to these plastics. A lubricating film of grease can be formed between the first and second gear.

The plastic part can have a sleeve or a hollow cylinder, on the outside of which the teeth of the first gear are provided in one area and on which two outwardly projecting collars are provided in another area, between which the at least one permanent magnet is embedded. The sleeve can be attached to an axle. The axle can be arranged in a rotationally stable manner or rotatably in the sleeve.

The collars can have projecting elements on sides facing each other and/or the sleeve can have projecting elements on an outer side between the collars. The permanent magnet can have recesses in which these projecting elements engage. This ensures that the permanent magnet is connected to the sleeve in a rotationally stable manner.

The motor can be a brushless DC motor.

### BRIEF DESCRIPTION OF THE DRAWINGS

An exemplary embodiment of an arrangement which is a component of an actuator according to an embodiment of the invention and has a plastic part, a permanent magnet and a second gear is shown in more detail in the drawings. In the figures:

FIG. 1 shows a view of the arrangement with the permanent magnet being transparent;

FIG. 2 shows a top view of the arrangement; and

FIG. 3 shows a sectional view along line A-A in FIG. 2.

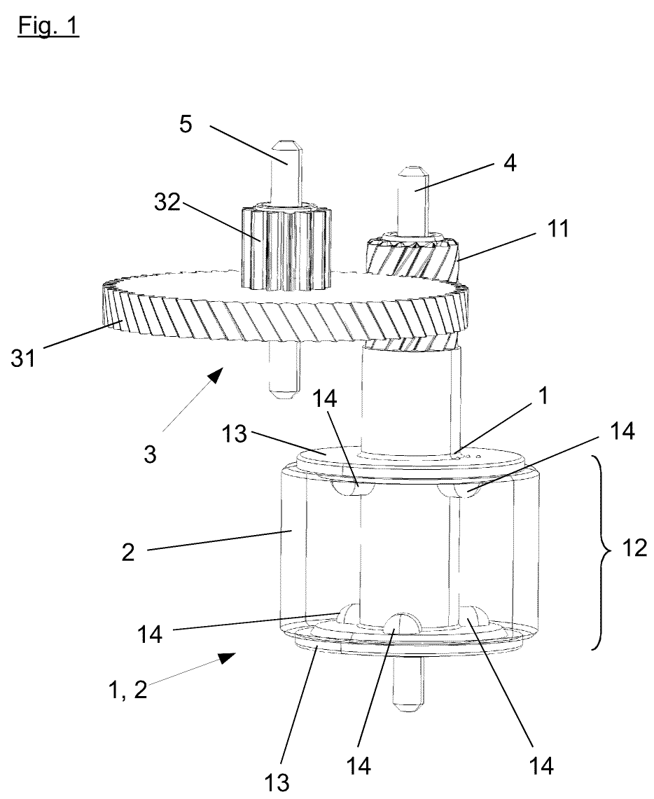

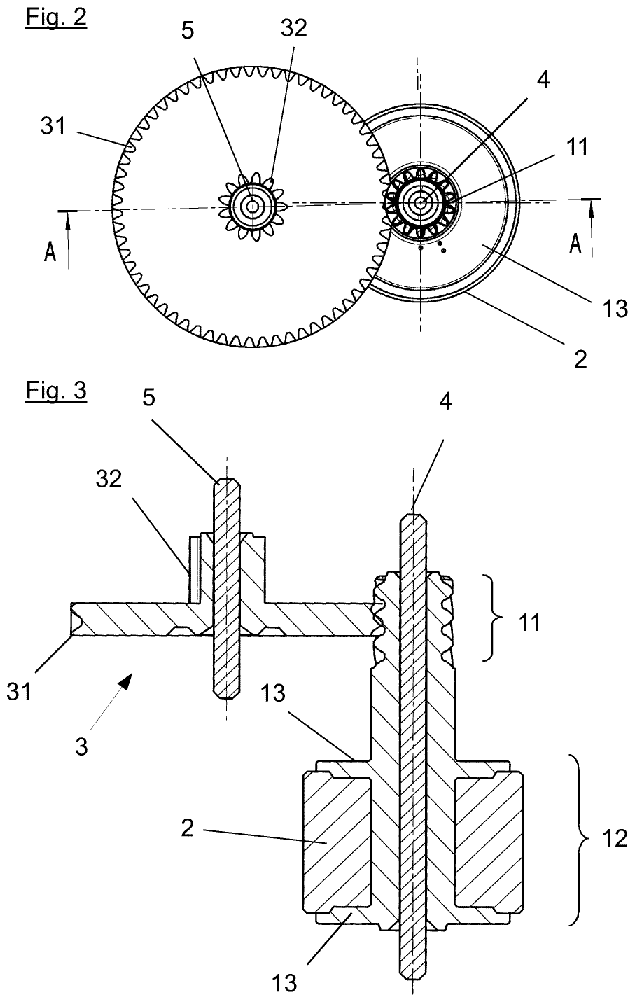

### DETAILED DESCRIPTION OF THE CURRENT EMBODIMENT

The arrangement shown in the drawings, which can be used in an actuator according to the invention, has the plastic part 1, the permanent magnet 2, the second gear 3, a first axle 4 and a second axle 5.

The plastic part 1 is a plastic injection molded part. It has a sleeve 11, 12 with a first area 11, which forms a first gear of the arrangement. The teeth of the first gear have a helix angle of approximately 30°. Collars 13 are connected to a second area 12 of the sleeve 11, 12. These have a distance from each other which corresponds to the width of the permanent magnet 2. The permanent magnet is also formed from a sleeve. It sits on the second area 12 and between the collars 13.

Between these two collars 13, on the sides of the collars 13 facing each other and adjacent to the outside of the second area 12 of the sleeve, projecting elements 14 are provided which engage in recesses of the permanent magnet 2, which are distributed on the inside of the permanent magnet 2. These elements 14, which engage in the recesses of the permanent magnet 2, prevent the permanent magnet 2 from rotating relative to the plastic part 1.

The plastic part 1 is an injection molded part which is molded onto the permanent magnet 2.

The plastic part 1 and the permanent magnet 2 form a rotor of a motor of the actuator according to the invention.

The first axle 4 is inserted into the sleeve 11, 12 and the plastic part 1 and the axle 4 are connected to each other in a rotationally stable manner.

The second gear 3 is also a plastic injection molded part. It has a first area 31 with a first diameter and a second area 32 with a diameter smaller than the first diameter. The first area 31 is helically toothed complementary to the first gear. In the second area 32, straight teeth are provided, on which the movement of the second gear can be transferred.

### LIST OF REFERENCE NUMBERS

1 plastic part
11 first area/first gear
12 second end area
13 collar
14 projecting elements
2 permanent magnet
3 second gear
31 first area of the second gear
32 second area of the second gear
4 first axle
5 second axle

The above description is that of a current embodiment of the invention. Various alterations and changes can be made without departing from the spirit and broader aspects of the invention. This disclosure is presented for illustrative purposes and should not be interpreted as an exhaustive description of all embodiments of the invention or to limit the scope of the claims to the specific elements illustrated or described in connection with these embodiments. Any reference to elements in the singular, for example, using the articles “a,” “an,” “the,” or “said,” is not to be construed as limiting the element to the singular.

1. An actuator comprising:
a motor; and
a gearing mechanism;
wherein the motor has a stator and a rotor with at least one permanent magnet;
wherein the gearing mechanism comprises a first gear and a second gear which mesh with each other;
wherein the actuator has a plastic part which forms a part of the rotor and the first gear;
wherein the permanent magnet is embedded in the plastic part; and
wherein the first and second gears have helical teeth.

2. The actuator according to claim 1, wherein the plastic part is a plastic injection molded part and in that the permanent magnet is overmolded with the plastic of the plastic injection molded part.

3. The actuator according to claim 1, wherein the second gear is a plastic part.

4. The actuator according to claim 1, wherein the second gear is an injection molded plastic part.

5. The actuator according to claim 1, wherein the helical teeth have a helix angle of approximately 30°.

6. The actuator according to claim 1, wherein the plastic part is made of polyoxymethylene.

7. The actuator according to claim 1, wherein the second gear is made of polyamide.

8. The actuator according to claim 1, wherein the second gear is made of polyamide 6 reinforced with 40% glass fibers by weight.

9. The actuator according to claim 1, wherein a lubricating film of a lubricating grease is formed between the first and the second gear.

10. The actuator according to claim 1, wherein the plastic part has a sleeve on which the helical teeth of the first gear are provided in one region and on which two outwardly projecting collars are provided in another region, between which the at least one permanent magnet is embedded.

11. The actuator according to claim 10, wherein the collars have projecting elements on sides of the collars facing each other, and the permanent magnet has recesses in which the projecting elements engage.

12. The actuator according to claim 10, wherein the collars have projecting elements facing the sleeve, and the permanent magnet has recesses in which the projecting elements engage.

13. The actuator according to claim 1, wherein the motor is a brushless DC motor.
